(19) United States
(12) Patent Application Publication
(10) Pub. No.: US 2008/0195386 A1
(43) Pub. Date: Aug. 14, 2008

(54) Method and a Device For Performing an Automatic Dubbing on a Multimedia Signal

(75) Inventors: Adolf Proidl, Wien (AT); Nina Angelova, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/916,030

(22) PCT Filed: May 24, 2006
(86) PCT No.: PCT/IB06/51656

§ 371 Date: Nov. 30, 2007

(30) Foreign Application Priority Data
May 31, 2005 (EP) 05104686.0

(51) Int. Cl. G10L 15/26

(52) U.S. Cl. 704/235; 704/E15.043

(57) ABSTRACT

A method and a device for performing an automatic dubbing on a multimedia signal This invention relates to a method and a system for performing automatic dubbing on a multimedia signal, such as a TV or a DVD signal, where the multimedia signal comprises information relating to video and speech and further comprises textual information corresponding to the speech. Initially the multimedia signal is received by a receiver. The speech and the textual information are then, respectively, extracted which results in said speech and textual information. The speech is analyzed resulting in at least one voice characteristic parameter, and based on the at least one voice characteristic parameter the textual information is converted to a new speech.

The present invention relates to a method and a system for performing automatic dubbing on a multimedia signal, such as a TV or a DVD signal, where said multimedia signal comprises information relating to video and speech and further comprises textual information corresponding to said speech.

In the last years there has been some development in text-to-speech & speech-to-text systems.

In U.S. Pat. No. 6,792,407 a text-to-speech system is disclosed, where acoustic characteristics of stored sound units from a concatenate synthesizer are compared to acoustic characteristics of a new target speaker. The system then assembles an optimal set of text which the new speaker then reads. The text selected for the new speaker to read is then used with the synthesizer to adapt to the voice quality and characteristic particular to the new speaker. The drawback with this disclosure is that the system depends on using said speaker, typically an actor, for reading the text loud, and the voice quality is adapted to his/her voice. Therefore, for a movie which is to be synchronized consisting of 50 actors, 50 different speakers are needed for reading texts loud. This system therefore requires enormous man power for such synchronization. Also, the voice of the new speaker can be different from the voice of the original speaker in e.g. a movie. Such differences can easily change the characters of the movie, such as when the voice of the actor in the original voice has a very special voice character.

WO 2004/090746 discloses a system for performing automatic dubbing on an incoming audio-visual stream, where the system comprises means for identifying the speech content in the incoming audio-visual stream, a speech-to-text converter for converting the speech content into a digital text format, a translation system for translating the digital text into another language or dialect; a speech synthesizer for synthesizing the translated text into a speech output, and a synchronizing system for synchronizing the speech output to an outgoing audio-visual stream. This system has the drawback that the speech to text is very error prone, especially in the presence of noise. In a movie there is always background music or noise that can't be filtered out completely by the speech isolator. This will result in translation errors during the speech to text translation. Furthermore, the speech to text translation is a computational heavy task requiring “supercomputer” processing power to achieve acceptable results without training of the speaker when using a general purpose vocabulary.

It is an object of the present invention to provide a system and a method which can be used for a simple and effective dubbing on a multimedia signal, where the voice characteristics of the actors are maintained.

According to one aspect the present invention relates to a method of performing automatic dubbing on a multimedia signal, such as a TV or a DVD signal, where said multimedia signal comprises information relating to video and speech, and further comprises textual information corresponding to said speech; said method comprises the steps of:

receiving said multimedia signal,

extracting respectively the speech and the textual information from said multimedia signal,

analyzing said speech to obtain at least one voice characteristic parameter, and based on said at least one voice characteristic parameter,

converting said textual information to a new speech.

Thereby, a simple and automatic solution is provided for reproducing said new speech in a way that the voice characteristic of the initial speech will be preserved, although the language has been changed, i.e. an actor's voice in one language will be similar to or the same as the same actor's voice in another language. The new speech can even be in the same language but with a different dialect. In that way the actor will appear as if he/she is capable of speaking said languages fluently. This is of particular advantage in e.g. countries where e.g. the movies are dubbed, which obviously requires an extremely high man power and costs. Other advantages are e.g. for people who simply prefer to watch a movie in their own language, or for elderly people who have problems reading sub titles. The present method enables people at home to select whether the DVD movie or TV broadcast program they are watching is to be played as dubbed or with subtitle, or both.

In an embodiment, said at least one voice characteristic parameter comprises one or more parameters from the group consisting of: pitch, melody, duration, phoneme reproduction speed, loudness, timbre. In that way, the actor's voices can be animated very precisely, although the language has been changed.

In one embodiment, said textual information comprises subtitle information on a DVD, teletext subtitles or closed caption subtitles. In another embodiment, said textual information comprises information which is extracted from the multimedia signal by means of text detection and optical character recognition.

In an embodiment, said original speech is removed and replaced by said new speech which is inserted into a new multimedia signal, said new multimedia signal comprising said new speech and said video information. In an embodiment said new speech is inserted into the new multimedia signal at a predetermined time delay. In that way, the time needed for generating said new speech is taken into account. The playing of the video information is therefore delayed until the reproduction of the text has taken place. This time delay is e.g. fixed as 1 sec. which means that the generated new speech is inserted into the new multi media signal after 1 sec.

In an embodiment, the timing of inserting said new speech into said new multi media signal corresponds to the timing of displaying said textual information on said video in the received multimedia signal. In that way, a very simple solution is provided for controlling the dubbing of the new speech on the multimedia signal, where the timing of playing the textual information in the received multimedia signal is used as reference timing for inserting the new speech into the new multi media signal.

In an embodiment, the timing of inserting said new speech into said new multimedia signal is based on sentence boundaries identified by capital letters and punctuation within the textual information. In that way, the accuracy of the dubbing can be enhanced further.

In an embodiment, the timing of inserting said new speech into said information relating to the multimedia signal is based on speech boundaries identified by silences within the received speech information. In that way, a solution is provided for controlling the dubbing of the new speech on the multimedia signal, where lip-synchronization at the beginning of sentences is maintained, wherein the timing of inserting the new speech into the new multimedia signal corresponds to the timing of the end of the first silence observed in the received speech information.

In a further aspect, the present invention relates to a computer readable medium having stored therein instructions for causing a processing unit to execute said method.

According to another aspect, the present invention relates to a device for performing automatic dubbing on a multimedia signal, such as a TV or a DVD signal, where said multimedia signal comprises information relating to video and speech and further comprises textual information corresponding to said speech, wherein said device comprises:

a receiver for receiving said multimedia signal,

a processor for extracting respectively the speech and the textual information from said multimedia signal,

a voice analyzer for analyzing said speech to obtain at least one voice characteristic parameter,

a speech synthesizer for, based on said at least one voice characteristic parameter, converting said textual information to a new speech

In that way, a device is provided which may e.g. be integrated into home devices such as TV's, and which is of capable of automatically dubbing e.g. a video, DVD, TV film with subtitle information into another language and simultaneously preserving the original voices of the actors. In that way, the character of the actors will also be preserved.

These and other aspects of the invention will be apparent from and elucidated with reference to the embodiment(s) described hereinafter.

In the following preferred embodiments of the invention will be described referring to the figures, where

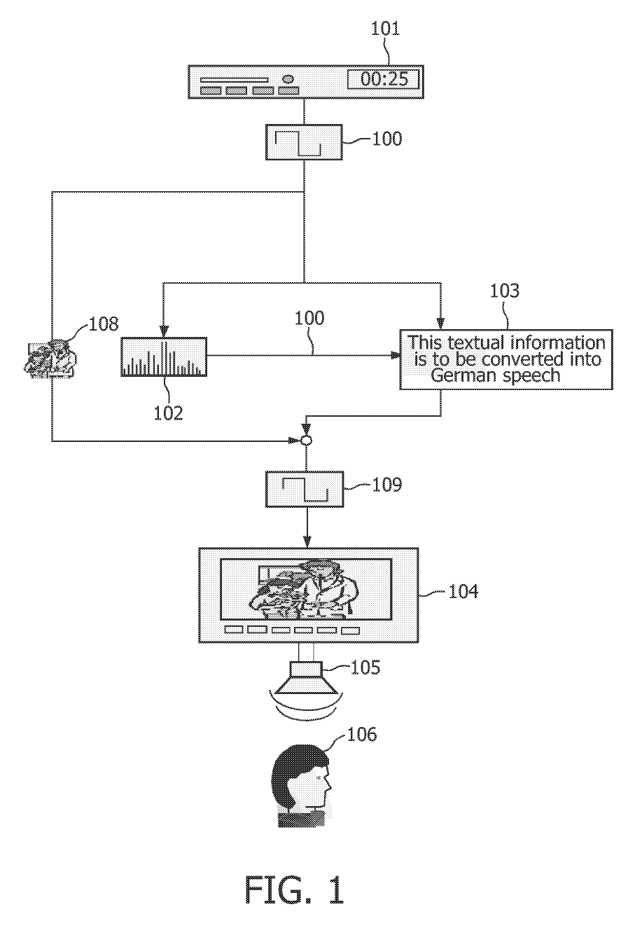

FIG. 1 illustrates one example according to the present invention, showing a user watching a movie on television,

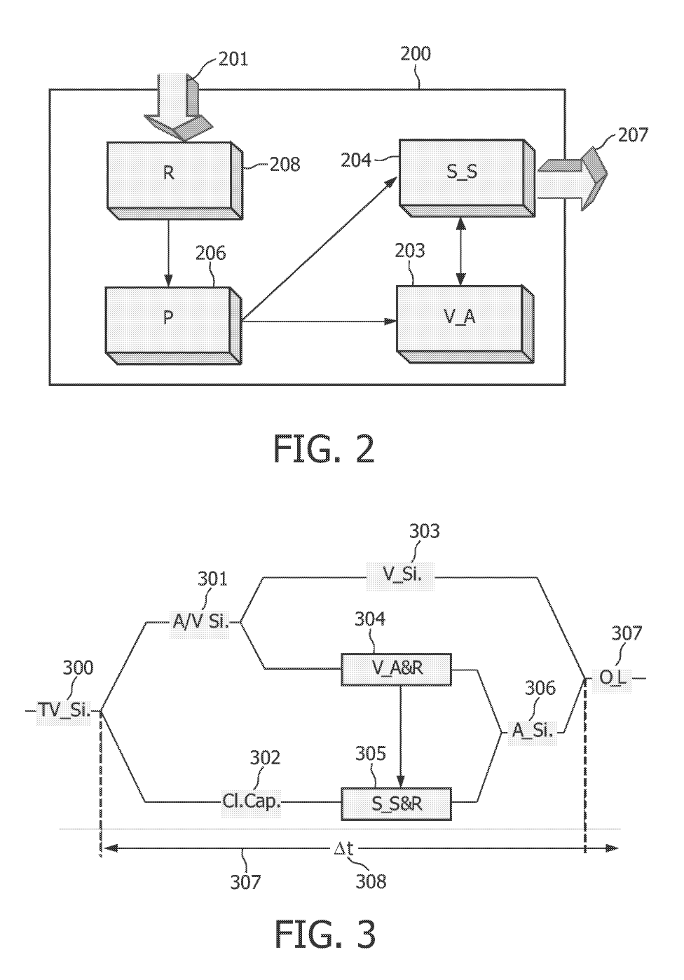

FIG. 2 shows a system according to the present invention,

FIG. 3 illustrates graphically an incoming multimedia signal, e.g. a TV signal, being separated into A/V signal and textual information, and

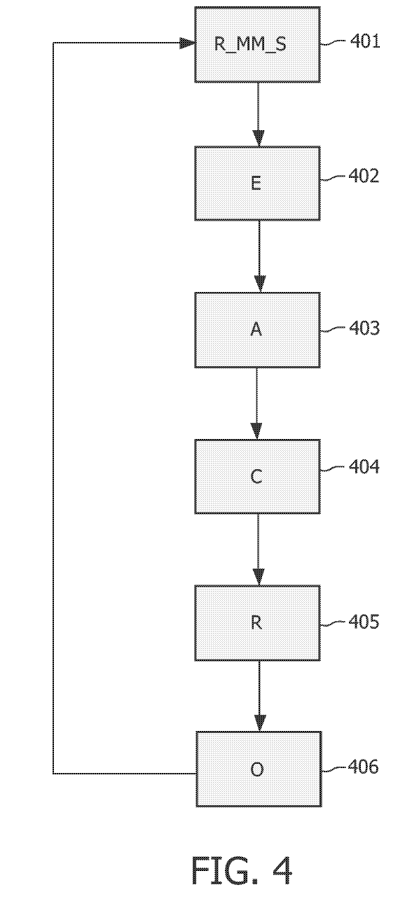

FIG. 4 shows a flow chart illustrating the method of performing automatic dubbing on a multimedia signal.

FIG. 1 is an example showing a user 106 watching a movie on a television 104 from a DVD player 101, hard disc player and the like, and wanting to see the movie dubbed in another language, instead of watching the movie only with subtitles. The user 106 could in this case be an elderly person who has problems reading the subtitles, or which for some other reasons prefers to see the movie dubbed, such as for learning a new language. By appropriate selection, e.g. on a remote controller, the user 106 makes said selection of playing the movie as dubbed. Besides being capable of making said selection, the movie is furthermore dubbed whereby the voices of the actors in the dubbed version are similar to or the same as in the original version, e.g. George Clooney's voice in English will be similar to George Clooney's voice in German.

As illustrated in the figure, the received multimedia signal (TV signal, DVD signal etc) 100 comprises information relating to video 108, information relating to speech in 102 and textual information in 103 which is e.g. DVD subtitle information, or teletext subtitles of broadcasts performed in the original language.

From the speech in 102 characteristic voice parameters are extracted from the actor's voice using a voice analyzer. These parameters can e.g. be pitch, melody, duration, phoneme reproduction speed, loudness, timbre etc. Parallel to extracting said voice parameters from the speech in 102 the textual information in 103 is converted to audible speech using a speech synthesizer. In that way textual information in e.g. English is converted into e.g. German speech. The voice parameters are then used as control parameters for controlling the speech synthesizer when reproducing the speech created, in this case to control the German speech so that the actors appear to be speaking German. Finally, the reproduced speech is inserted into a new multi media signal 109, comprising said video information 108 and the background sound, e.g. music etc., and played via a speaker 105 for the user 106.

In one embodiment the timing for controlling the insertion of the reproduced speech signal into the new multi media signal 109 corresponds to the timing of displaying the textual information in 103 on the video 108 in the received multimedia signal 100. In that way the timing of displaying the textual information in 103 in the received multimedia signal 100 is used as reference timing for inserting the new speech into the new multi media signal 109. The textual information in 103 could be a textual package displayed at one instant of time in the multimedia signal 100, wherein the speech resulting thereof is displayed at the same instant of time as the text appeared in the multimedia signal 100. Simultaneously, the subsequent textual package must be processed for the subsequent inserting into the new multi media signal. In that way, the textual information must be processed continuously and the reproduced speech must continuously be inserted into the new multi media signal 109.

In another embodiment the timing for inserting the reproduced speech signal into the new multi media signal 109 is based on a fixed time delay of Δt for the video 108 and Δt-tₚ for the speech in 102, where tₚ is the time needed for processing the speech.

Here it is has been assumed that the audio signal in 102 has been split into a speech signal and other, different audio sources comprised in the incoming audio signal. Such a separation is well established in the modern literature. A common prior art method for separating different audio sources from an audio signal is “Blind Source Separation/Blind Source Decomposition” using “Independent Component Analysis” (ICA), which is e.g. disclosed in the following references: “N. Mitianoudis, M. Davis, Audio Source Separation of convolutive mixtures, IEEE Transaction on Speech and Audio Processing, vol. 11, issue 5, pp. 489-497, 2002” and “P. Common, Independent component analysis, a new concept?, Signal Processing 36(3), pp. 287-314, 1994”. Once said audio signal 102 has been separated from different audio sources, it must be identified as belonging to one of the pre-determined (general) audio classes, e.g. speech. An example of a reference which discloses a method which successfully delivers this kind of separation is by: Martin F. McKinney, Jeroen Breebaart; “Features for Audio and Music Classification”, Proceeding of the International Symposium on Music Information Retrieval (ISMIR 2003), pp. 151-158, Baltimore, Md., USA, 2003.

It has until now been assumed that the user 106 is watching the movie in real time. The user might also be interested in dubbing the movie on e.g. a CD disc and watch it at a later time. In such cases, the process of analyzing the speech could be done for the complete movie and subsequently be inserted into the new multi media signal.

FIG. 2 shows a device 200 according to the present invention for performing automatic dubbing on a multimedia signal, such as a TV or a DVD signal, where the multimedia signal comprises information relating to video and speech and further comprises textual information corresponding to said speech. As shown, the device 200 comprises a receiver (R) 208 for receiving multimedia signal 201, a processor 206 for extracting respectively the speech and the textual information from said multimedia signal, a voice analyzer (V_A) 203 for processing voice parameters from the speech, and a speech synthesizer (S_S) 204 for converting the textual information into speech of different language or dialect than the original speech and for replacing the original speech with said new speech. The processor (P) 206 uses the voice parameters for controlling the speech synthesizer (S_S) 204 in a way that the output speech 207 preserves the original voice of the actor, although the language of the speech has been changed.

In an embodiment the processor (P) 206 is further adapted to insert the processed or reproduced speech 207 into the new multi media signal as discussed previously.

FIG. 3 illustrates graphically where an incoming multimedia signal, e.g. a TV signal (TV_Si) 300 is separated into an A/V signal (A/V Si) 301 and closed captioning (C1. Cap) 302, i.e. textual information. The textual information is converted into new speech (S_S&R) 305 of a different language or dialect, which replaces the original speech in the original TV signal (TV_Si) 300. The speech comprised in said A/V signal (A/V Si) 301 is analyzed (V_A&R) 304 and based thereon one or more voice parameters are obtained. These parameters are then used to control the reproduction of the new speech (S_S&R) 305. The speech comprised in said A/V signal (A/V Si) 301 is removed (V_A&R) 304 and replaced by the reproduced, new speech, resulting in a new audio signal (A_Si.) 306 comprising said new language or dialect with the original voice characteristic. Finally, the audio signal (A_S) 306 is combined with the video signal (V_Si.) 303 resulting in the new multi media signal, here new TV signal (O_L) 307.

Shown is also a time line 307 illustrating the time needed from where the initial TV signal (TV_S) 300 is separated until the audio signal (A_S) 306 is inserted together with the video signal (V_Si) 303 into the new multi media signal. This time difference 308 may be considered as predetermined and fixed and aimed at the time needed for processing said new audios signal.

FIG. 4 shows a flow chart illustrating the method of performing automatic dubbing on a multimedia signal, such as a TV or a DVD signal, where the multimedia signal comprises information relating to video and speech and further comprises textual information corresponding to the speech. Initially the multimedia signal is received (R_MM_S) 401 by a receiver. The speech and the textual information are then, respectively, extracted (E) 402 which results in said speech and textual information. The speech is analyzed (A) 403 resulting in at least one voice characteristic parameter. These voice parameters can, as mentioned previously, comprise pitch, melody, duration, phoneme reproduction speed, loudness, timbre. Also, the textual information is converted into a new speech (C) 404 which is of a different language or dialect than the speech in the original multimedia signal. Finally, the voice characteristic parameter(s) is used for reproducing (R) 405 the new speech so that the voice of the new speech is similar to the voice of the original speech, although the speech is of a different language. In that way, actors will appear to be able to speak different languages fluently, although he/she is not capable of doing so. Finally, the reproduced new speech is inserted (O) 406 together with the video information into the new multi media signal and played to the user.

Steps 401-406 are continuously repeated since the video information is played continuously (with said time delay) to the user.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of performing automatic dubbing on a multimedia signal (100), such as a TV or a DVD signal, where said multimedia signal (100) comprises information relating to video (108) and speech (102) and further comprises textual information (103) corresponding to said speech (102); said method comprises the steps of:
receiving said multimedia signal (100),
extracting respectively the speech (102) and the textual information (103) from said multimedia signal (100),
analyzing said speech to obtain at least one voice characteristic parameter, and based on said at least one voice characteristic parameter,
converting said textual information (103) to a new speech (207).

2. A method according to claim 1, wherein said at least one voice characteristic parameter comprises one or more parameters from the group consisting of: pitch, melody, duration, phoneme reproduction speed, loudness, timbre.

3. A method according to claim 1, wherein said textual information (103) comprises subtitle information on a DVD, teletext subtitles, or closed captioning subtitles.

4. A method according to claim 3, wherein said textual information (103) comprises information which is extracted from the multimedia (100) signal by means of text detection and optical character recognition.

5. A method according to claim 1, wherein said original speech is removed and replaced by said new speech (207) which is inserted into a new multimedia signal (109), said new multimedia signal (109) comprising said new speech (207) and said video (108) information.

6. A method according to claim 5, where said new speech (207) is inserted into said new multi media signal (109) at a predetermined time delay (308).

7. A method according to claim 5, wherein the timing of inserting said new speech into said new multimedia signal (109) corresponds to the timing of displaying said textual information (103) on said video (108) in the received multimedia signal (100).

8. A method according to claim 5, wherein the timing of inserting said new speech into said new multimedia signal (109) is based on sentence boundaries identified by capital letters and punctuation within the textual information.

9. A method according to claim 5, wherein the timing of inserting said new speech into said new multimedia signal (109) is based on speech boundaries identified by silences within the received speech information.

10. A computer readable medium having stored therein instructions for causing a processing unit to execute a method according to claim 1.

11. A device for performing automatic dubbing on a multimedia signal (100), such as a TV or a DVD signal, where said multimedia signal (100) comprises information relating to video (108) and speech (102) and further comprises textual information (103) corresponding to said speech (102), wherein said device comprises:
a receiver (208) for receiving said multimedia signal (100),
a processor (206) for extracting respectively the speech and the textual information from said multimedia signal (100),
a voice analyzer (203) for analyzing said speech (102) to obtain at least one voice characteristic parameter,
a speech synthesizer (204) for, based on said at least one voice characteristic parameter, converting said textual information (103) to a new speech (207).
